(19) United States
(12) Patent Application Publication
(10) Pub. No.: US 2020/0290057 A1
(43) Pub. Date: Sep. 17, 2020

(54) Botanical Quick Freeze Method and System

(71) Applicant: Engip, LLC, Conroe, TX (US)

(72) Inventor: Lee Hilpert, Hollister, CA (US)

(73) Assignee: Engip, LLC, Conroe, TX (US)

(21) Appl. No.: 16/781,615

(22) Filed: Feb. 4, 2020

Related U.S. Application Data
(60) Provisional application No. 62/801,672, filed on Feb. 6, 2019.

(51) Int. Cl. B02C 19/00; B02C 23/24; F25D 19/00; F25D 3/10

(52) U.S. Cl. CPC B02C 19/0018; F25D 3/10; F25D 19/006; B02C 23/24

(57) ABSTRACT

A method and system providing for comminution and concurrent flash freezing of botanical biomass. The botanical biomass is introduced into a pneumatic loop where it is subject to comminution and a cryogenic process within said pneumatic loop and subsequently discharged from said pneumatic loop.

### CROSS-REFERENCE TO RELATED APPLICATIONS

This application claims priority to U.S. provisional application Ser. No. 62/801,672 filed Feb. 6,2019, the entire contents of which is hereby incorporated by reference thereto.

### BACKGROUND OF THE INVENTION

### Field of the Invention

This invention is directed to a method and apparatus providing for the preparation of botanical biomass to enhance solvent extraction process.

### Description of Related Arts

There are many well-known solvent based extractions methods and apparatus to realize solvent based extractions. For example; Supercritical carbon dioxide can be an effective solvent extraction method when utilized at certain temperatures and pressures. Hydrocarbons such as butane and hexane can be an effective solvent extraction method when utilized at certain temperatures and pressures. Ethanol can be an effective solvent extraction method when utilized at certain temperatures and pressures.

The efficiency of solvent based extraction methods is very dependent on the mechanics of the method used to expose botanical biomass to the solvent. Critical variables of the method utilized to expose botanical biomass to a solvent that have the most impact on quality and efficiency are: a) the saturation level of the solvent, b) the amount of time where the biomass is exposed to the solvent, c) the temperature of the solvent, d) the temperature of the biomass, and e) the surface area volume ratio of the biomass. It is a critical first step to properly prepare the botanical biomass so as to align with and enhance the solvent extraction process.

Typical industrial preparation technology includes first reducing the size of the botanical biomass via milling. Most often this is a manual process where a technician visually determines the correct amount of reduction applied to the botanical biomass. This manual procedure that relies on the skill and diligence of the technician is at best unreliable.

Other industrial milling technology utilizes a screen to control the size of the finished material. There is a practical limitation to the minimum size obtainable by this technology. Very small screen openings cannot be used when processing botanical biomass without risk of blinding or plugging.

A next step typical of current botanical biomass preparation is to reduce the temperature to stabilize the light end constituents of the botanical oil and to reduce the activity of the water-soluble constituents. Again, current technology is a manual process where a technician spreads the botanical biomass onto a tray to subsequently be placed in a freezer. After some time has passed, usually 24 hrs, the prepared botanical biomass is deemed ready for the solvent extraction process.

Current technology utilized within the industry does not provide for a means of precisely controlling the variables associated with preparation of botanical biomass for subsequent solvent extraction processes.

Therefore, there is a need for a method and apparatus that sufficiently controls the variables associated with preparation of botanical biomass for subsequent solvent extraction processes.

### BRIEF SUMMARY OF THE INVENTION

The present invention addresses these and other needs by providing a system and apparatus that sufficiently controls the variables associated with preparation of botanical biomass for subsequent solvent extraction processes.

The new and unique features of this invention include a milling device rotating at a high rate of speed. The milling device is of a radial blade design encased in a housing with a principally circular shaped inlet that is concentrically aligned with the axis of rotation of the rotating radial milling feature. The housing also includes a principally circular shaped outlet that is tangent to the arc formed at the periphery of the rotating radial blade. The outlet is in conveyance communication with a heat exchanger to remove heat from the milled botanical biomass. The heat exchanger is in further conveyance communication with the inlet of the housing via the branch of a suitable tee connection. The run of the tee is connected to the housing and a suitable feed conveyor.

### BRIEF DESCRIPTION OF THE DRAWINGS

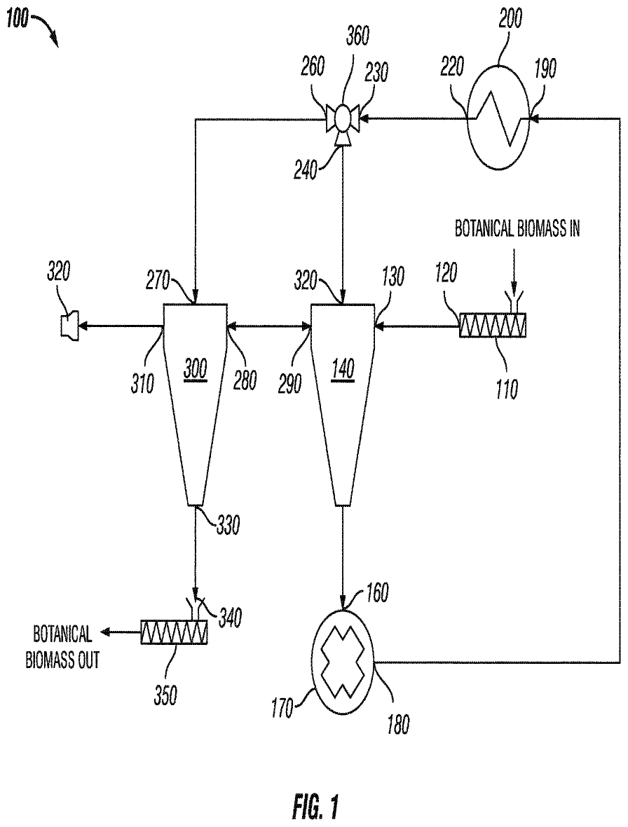

For a detailed description of the preferred embodiment of this invention, reference will be made to the accompany drawing. FIG. 1 is a schematic flow diagram of a process and apparatus according to an embodiment of the invention

### DETAILED DESCRIPTION OF AN EMBODIMENT

FIG. 1 depicts flow diagram 100 of the process of this invention. Flow diagram 100 includes feed conveyor 110 that includes outlet 120. Outlet 120 is mechanically coupled to and in mechanical conveyance communication with Inlet 130 of cyclone 140. Outlet 150 of cyclone 140 is mechanically coupled to and in pneumatic communication with Inlet 160 of radial miller 170. Outlet 180 of radial miller 170 is mechanically coupled to and in pneumatic communication with Inlet 190 of heat exchanger 200. Outlet 220 of heat exchanger 200 is mechanically coupled to and in pneumatic communication with inlet 230 of diverter valve 360. Outlet 240 of diverter valve 360 is mechanically coupled to and in pneumatic communication with inlet 250 of cyclone 140.

Outlet 260 of diverter valve 360 is mechanically coupled to and in pneumatic communication with inlet 270 of cyclone 300. Outlet 290 of cyclone 140 is mechanically coupled to and in pneumatic communication with Inlet 280 of Cyclone 300. Outlet 330 of cyclone 300 is mechanically coupled to and in mechanical conveyance communication with inlet 340 of discharge conveyor 350. Outlet 310 of cyclone 300 is mechanically coupled to and in pneumatic communication with atmospheric vent 320.

A pneumatic loop is formed via outlet 150 of cyclone 140, inlet 160 of radial miller 170, radial miller 170, Outlet 180 of radial miller 170, inlet 190 of heat exchanger 200, heat exchanger 200, outlet 220 of heat exchanger 200, inlet 230 of diverter valve 360, diverter valve 360, outlet 240 of diverter valve 360, inlet 250 of cyclone 140, and cyclone 140. The pneumatic loop will be referenced herein as the “operating loop”.

Again, referring to FIG. 1. and now describing in detail a method according to an embodiment of this invention.

Processing begins with initialization of the system in preparation of receiving botanical biomass including confirmation that diverter valve 360 is configured so that inlet 230 of diverter, valve 360 is in pneumatic communication with outlet 240 of diverter valve 360, radial miller 170 is operating at a sufficient speed, and the pneumatic velocity within the operating loop is stable and sufficient. The just describe initialization, resultant configuration, and intended functionality is referred to as “milling cycle”. Subsequent to initialization and now describing the milling cycle, previously screened botanical biomass suitable for solvent extraction and compatible with the method of this invention is received at feed conveyor 110. Botanical biomass received at feed conveyor 110 is discharged at outlet 120 of feed conveyor 110. Botanical biomass discharged at outlet 120 of feed conveyor 110 is mechanically conveyed to and received at inlet 130 of cyclone 140.

Feed conveyor 110 is of a variable conveyance rate design. The conveyance rate of feed conveyor 110 is modulated based on the pressure within the operating loop measured near, but downstream, of outlet 180 of radial miller 170. Botanical biomass from the feed source is mechanically conveyed via feed conveyor 110, Outlet 120 of feed conveyor 110, and inlet 130 of cyclone 140 into the operating loop at cyclone 140. Once a sufficient amount of botanical biomass has been introduced into the operating loop, based on the measured pressure at outlet 180 of radial miller 170, feed conveyor 110 will pause, reducing the conveyance rate to zero.

Botanical biomass received at cyclone 140 is, pneumatically conveyed via outlet 150 of cyclone 140 and inlet 160 of radial miller 170 into radial miller 170 very near the axis of rotation of radial miller 170.

Radial miller 170 is of a radial blade design. Each radial blade of radial miller 170 features a precision, replaceable, cutting blade. Radial miller 170 is designed to create both centrifugal and pneumatic forces. The centrifugal and pneumatic forces act upon both the gas and botanical biomass within radial miller 170 affecting the gas within radial miller 170 to compress at the periphery of the housing of radial miller 170 and affecting the botanical biomass to congregate at the periphery of the housing of radial miller 170. The compressed gas and the botanical biomass are subsequently discharged at Outlet 180 of radial miller 170. Outlet 180 of radial miller 170 is located principally tangent to, the axis of rotation at the periphery of the housing of radial miller 170.

Outlet 180 of radial miller 170 features a cutting blade designed to interface with the cutting blade of the radial blade feature of radial miller 170. As botanical biomass transitions from the interior portion of the housing of radial miller 170 to outlet 180 it is exposed to the interfacing cutting blade of outlet 180 and the cutting blade of the radial blade of radial miller 170.

Radial miller 170 may feature one or more radial blades. Additionally, outlet 180 of radial miller 170 may future one or more cutting blades.

The gas and botanical biomass discharged at outlet 180 of radial miller 170 is pneumatically conveyed to and received at inlet 190 of heat exchanger 200.

Heat exchanger 200 is of a cryogenic design where a cryogenic liquid, such as cotton dioxide or nitrogen is sprayed, in a fine mist, onto the exposed surfaces of the milled botanical biomass. Heat exchanger 200 is of sufficient capacity to “flash freeze” the botanical biomass as it passes through heat exchanger 200.

Flash freezing is a known art and commonly used in biomass preparation such as fruits and vegetables for human consumption.

The compressed gas and flash frozen botanical biomass are discharged at outlet 220 of heat exchanger 200. The compressed gas and flash frozen botanical biomass discharged at outlet 220 of heat exchanger 240 is pneumatically conveyed to and received at inlet 230 of diverter valve 360. As previously disclosed, diverter valve 360 is configured, during milling operations, to discharge at outlet 240. Compressed gas and botanical biomass discharged at outlet 240 of diverter valve 360 is pneumatically conveyed to and received at inlet 250 of cyclone 140.

Cyclone 140 allows for the velocity of the pneumatic transport gas and the gas produced by the evaporating cryogenic fluid to slow sufficiently enough to no longer support conveyance of the botanical biomass. Cyclone 140 is vented to atmosphere via outlet 290 of cyclone 140, inlet 280 of cyclone 300, cyclone 300, outlet 310 of cyclone 300, and atmospheric vent 320. Cyclone 300 is vented to atmosphere via outlet 310 and atmospheric vent 320 to allow pressure equilibrium within the pneumatic loop.

Botanical biomass received at inlet 250 of cyclone 140 is discharged at outlet 150 of cyclone 140. Botanical biomass discharged at outlet 150 of cyclone 140 is pneumatically conveyed to and received at inlet 160 of radial miller 170.

Botanical biomass will continue to loop through the described operating loop for a certain amount of time with each loop causing a certain size reduction of the botanical biomass.

After a sufficient amount of time necessary to reduce the botanical biomass to an optimal extraction size, diverter valve 360 is configured to discharge at outlet 260.

This configuration where diverter valve 360 is configured to discharge at outlet 260 is herein referred to as the “discharge cycle”.

Compressed gas and botanical biomass discharged at outlet 260 of diverter valve 360 is pneumatically conveyed to and received at inlet 270 of cyclone 300.

Cyclone 300 allows for the velocity of the pneumatic transport gas and the gas produced by the evaporating cryogenic fluid to slow sufficiently enough to no longer support conveyance of the botanical biomass. Cyclone 300 is vented to atmosphere via outlet 310 of cyclone 300 and atmospheric vent 320.

Botanical biomass received at runlet 270 of cyclone 300 is discharged at outlet 330 of cyclone 300. Botanical biomass discharged at outlet 330 of cyclone 300 is conveyed to and received at Inlet 340 of discharge conveyor 350.

The just described cycles where the system of the invention is first configured for a milling cycle and subsequently configured for a discharge cycle constitutes one complete batch cycle. As many batch cycles as necessary to meet the demands of production requirements are completed in a fully automated, computer-controlled sequence.

Utilizing the new and unique features of the current invention provides for a fully automatic method and system to precisely control the comminution and concurrent flash freezing of botanical biomass in preparation for a solvent extraction process.

Although the present invention and its advantages have been described in detail, it should be understood that various changes, substitutions and alterations may be made herein without departing from the spirit and scope of the invention as defined by the appended claims.

What is claimed is:

1. A method for comminution and flash freezing of botanical biomass comprising of:
a. introducing the botanical biomass into a pneumatic loop;
b. subjecting the botanical biomass to comminution within the pneumatic loop;
c. further subjecting the botanical biomass to a cryogenic process within the pneumatic loop; and
d. discharging the comminuted cryogenic processed botanical biomass.

2. A system for comminution and flash freezing of botanical biomass comprising of:
a. a pneumatic loop;
b. a miller within the pneumatic loop to comminute botanical biomass;
c. a cryogenic heat exchanger in fluid communication with the miller to move heat from the botanical biomass; and
d. a diverter valve connected to an outlet of the cryogenic heat exchanger to discharge botanical biomass from the system.

3. The method of claim 1 further comprising the step of pre-screening the botanical biomass.

4. The method of claim 1 further including the step of directing the botanical biomass to a first cyclone and connecting an outlet of the first cyclone to a heat exchange.

5. The method of claim 4 further including the step of directing the output of the heat exchanger to a second cyclone.

6. The method of claim 5 further including the step of discharge ing the contents of the cyclone to a conveyor for further processing.
